(19) United States
(12) Patent Application Publication
(10) Pub. No.: US 2014/0265095 A1
(43) Pub. Date: Sep. 18, 2014

(54) Apparatus to support and position crown molding and multi buildup wall and ceiling crown molding

(71) Applicant: Gino A. Gaeta, (US)

(72) Inventor: Gino A Gaeta, Halifax, PA (US)

(73) Assignee: Gino A. Gaeta, Halifax, PA (US)

(21) Appl. No.: 13/797,455

(22) Filed: Mar. 12, 2013

(51) Int. Cl. E04F 21/00; B25B 11/00

(52) U.S. Cl. CPC E04F 21/00; B25B 11/00
USPC 269/46

(57) ABSTRACT

An apparatus that supports and positions multiple build up ceiling and crown moldings during installation. The base of the apparatus is temporarily retained on the wall surface at its top through a centered 45 degree slot and a partially driven nail located approximately ⅞ inch down the wall surface vertically from the ceiling. The base has a centered dovetail track to accommodate a vertically moving member that slides up and down and can be locked at a desired position with a thumb screw that engages the dovetail track. The top of this vertically moving member has a flat pivoting support that adjusts to any angled crown mold profile and locked into position with tightening round knobs until molding is secured to ceiling and wall. The base's bottom has a sliding adjustment rod with boot to adjust parallel from the wall surface to accommodate multiple buildups of ceiling and wall crown moldings and a thumb screw to lock adjustment rod and boot in the proper position from the wall.

### BACKGROUND OF THE INVENTION

Crown molding is a decorative material used in commercial and residential buildings for aesthetic purposes and more often to obscure imperfections where wall and ceiling intersect. Crown molding is also used to conceal pipes and wires along the ceiling and walls during renovation of commercial and residential buildings. Over the years in this trade more and more homeowners want crown molding incorporated with a multiple buildup of various wall and ceiling moldings (ogee cap, dentil, bed, cove and inverted 3¼ and 5¼ base molding) including crown molding for a more glamorous look. The installation of a long length of ceiling molding is cumbersome and difficult, and requires expertise and patience to measure and properly install along a horizontal wall and ceiling surface. The installation of crown molding and multiple buildup wall and ceiling crown molding often requires two or more workers due to measuring the overhead location, positioning and supporting of the crown moldings. Often two or more workers aren't available to help with the installation of the crown molding or it becomes too costly, labor wise, for more than one person to install. An independent contractor may also decline taking on the job of installing the crown molding because they work alone and are unable to secure a skilled worker and can't do the installation on their own. Accordingly, the present invention provides an apparatus that enables one person to install a single piece or a multiple buildup of wall and ceiling crown moldings of various dimensions, lengths and configurations horizontally on a wall and ceiling surface.

After conducting a search for any patented invention that existed to assist in the support and positioning of not only crown molding but a multiple buildup of a configuration of moldings to aid in the installation, my search came up with the following patented tool: Inventor—Patrick J. Smith, Peterborough, Calif., Filed Dec. 5, 2007, Date of patent, Apr. 17, 2012, U.S. Pat. No. 8,157,228B2, Title of Invention, Tool for Positioning Molding.

Specific problems involved in the prior art:

FIG. 3 drawing of the prior art, because of the defining slot 32 on the retaining member 28 and the incorporated location of the bass 28 on the base member 18, its vertical adjustment to the up and down movement limits its use for larger crown moldings.

FIGS. 1, 2, 3 and 4 drawings of the prior art, the upper portion 42 has a fixed and/or optional pivoting extension and no means to extend to support the total face profile of larger crown moldings.

The prior art has no means to adjust to multiple buildup of wall and ceiling moldings and no means to adjust the apparatus parallel to the wall's surface when installing various configurations of moldings horizontally on a wall and ceiling surface.

### FIELD OF INVENTION

The present invention relates to an apparatus for supporting and positioning lengths of wall and ceiling crown moldings of various sizes and configurations horizontally on wall and ceiling surfaces enabling a single individual to install wall and ceiling crown moldings by one self.

### SUMMARY OF THE INVENTION

The present invention relates to an apparatus for supporting and positioning wall and ceiling crown moldings of various lengths, sizes and configurations horizontally against a wall and ceiling surface for installation by a single individual at a job site.

The present invention apparatus incorporates a main flat base which is vertically attached on the wall surface temporarily. A supporting sliding member of the apparatus slides up and down vertically on a dovetail track embodied on the main flat base and a tightening thumb screw to lock the supporting sliding member at any desired vertical position to support the bottom edge of wall and ceiling molding. The apparatus has a pivoting flat upper body attached to the supporting sliding member by a threaded shaft and two round locking knobs that can be tightened when the pivoting flat member is adjusted to conform to the angled face of crown molding being installed.

The present invention apparatus incorporates a bottom portion of its base to be adjusted for multi build up wall and ceiling crown moldings.

### BRIEF DESCRIPTION OF THE DRAWINGS

To better understand the present invention more clearly, its functional use will be referenced in the accompanying drawings, in which:

FIG. 1 is a perspective view of the present apparatus 10 adapted to support and position a length of crown molding to be installed horizontally on a wall and ceiling surface.

FIG. 2 is a perspective view similar to FIG. 1 but without the length of crown molding. Also shown is an extension attachment 62 with tightening thumb screw 66.

FIG. 3 is an exploded perspective view of the apparatus 10 shown in FIGS. 1 and 2. Also included in this exploded perspective view are the three sizes of the extension attachments 54, 62, and 64.

FIG. 4 is a side elevation view: (A) of the apparatus 10 supporting and positioning 2 and ¼ inch crown molding. The second side elevation view (B) illustrates the apparatus 10 supporting and positioning a 3 and ⅝ inch crown molding with the use of an extension attachment 62 with tightening thumb screw 66.

FIG. 5 is a side elevation view of the apparatus 10 supporting and positioning (C) 5 and ¼ inch crown molding with the use of an extension attachment 64 and tightening thumb screw 68. The second side evaluation view illustrates the apparatus 10 supporting and positioning (D) 7 and ⅞ inch crown molding with the use of an extension attachment 54 and the tightening thumb screw 58.

FIG. 6 is a side elevation view (E), (F) and (G) of the apparatus 10 depicting the various stages and configurations of buildup wall and ceiling crown molding installation.

FIG. 6 (F) and (G) illustrate the use of the bottom portion of the apparatus 20 which incorporates the sliding adjustment rod 22 with connecting boot 24 and the tightening thumb screw 26 to lock the sliding adjustment rod 22 and boot 24 the distance required from the wall's surface 14.

### DETAILED DESCRIPTION OF THE INVENTION

Referring now to the drawings, a vertically wall mounted apparatus used to position and support horizontal ceiling and crown moldings is generally, by reference number 10 in FIG. 1. Tool 10 is positioning and supporting a 7 and ⅞ inch length of crown molding 12 to a vertical wall surface 14, and a horizontal ceiling surface 16.

Apparatus 10 embodies three components on its flat base 18 having a bottom portion 20 in FIGS. 1, 2 and 3 of drawings that consist of a sliding adjustment rod 22 with a connecting boot 24 and a thumb tightening screw 26. The boot 24 seats flush with the vertical wall surface 14 to accommodate for multiple buildup of wall and ceiling moldings as illustrated in the side elevation view drawing FIG. 6 G circled 28.

The middle portion 30, FIGS. 1, 2, and 3 of the flat base 18 have a vertically attached dovetail track 32, FIG. 3.

The top portion 34, FIGS. 1, 2, and 3 of the flat base 18 has a 45 degree slot 36 extending upward to a centrally located hole 38 to allow tool 10 to hang vertically on wall surface 14 on a partially driven in nail 40, FIGS. 1, 4, 5, and 6.

Apparatus 10 can later be removed off nail 40 from wall surface 14 by pivoting tool 10 to the left approximately 40 degrees on the walls surface 14 and then sliding the tool 10 to the right horizontally on the wall's surface 14 until tool disengages from nail 40 and then downward from behind crown molding 12. Further nailing is recommended to fasten crown molding 12 securely to wall 14 and ceiling 16.

Apparatus 10 has a supporting sliding member 42, FIGS. 1, 2, and 3 that incorporates a vertically centered dovetail groove 44 that slides up and down on a vertical dovetail track 32, FIGS. 2 and 3 that is centrally attached on the base 18. A thumb screw 46, FIGS. 1, 2, and 3 centered near the bottom of the supportive member 42 when tightened will engage the vertical dovetail track 32 and lock the sliding member 42, FIGS. 1 and 2 at a desired vertical position.

Engaging member 42 has a pivoting flat upper body 48, FIGS. 1, 2 and 3. The pivoting flat upper body attaches to top portion of engaging member 42 by a threaded shaft 50, FIG. 3 and two round locking knobs 52, FIG. 3. When the two locking knobs 52, FIG. 1 are tightened, the flat pivoting upper body 48 can adjust to any crown molding angle 12, FIG. 1.

The pivoting flat upper body 48, FIG. 1 can accept three various size extension attachments 54, 62 and 64, FIG. 3. The size of crown molding determines what extension attachment is used. FIG. 1 illustrates the use of extension attachment 54 due to the large surface face of the crown mold 12 that needs to be supported and positioned to wall 14 and ceiling surface 16 for installation. The three extension attachments 54, 62 and 64, FIG. 3 have a dovetail groove 56 that slide onto the dovetail track 60, FIG. 3 incorporated with the pivoting flat upper body 48. A thumb screw 58, FIG. 1 engages the dovetail track 60 to lock extension attachment 54 in place.

Engaging member 42 is slid up the vertical dovetail track 32 that is attached to flat base 18, FIG. 1 to support crown molding base 12 with thumb screw 46, FIGS. 1, 2, and 3 located near the bottom of engaging member 42 is tightened to secure member 42 in place.

The pivoting flat upper body 48 and the extension attachment 54 are then adjusted to the surface face of crown molding 12, FIG. 1. The thumb screw 58 on the extension attachment 54 is then tightened to engage the dovetail track 60 on the pivoting flat upper body 48. The two round locking knobs 52 that are threaded onto the ends of the threaded shaft 50 are then tightened to lock the pivoting flat upper body 48 and extension attachment 54 in proper position against wall surface 14 and ceiling 16. The ceiling or crown molding 12 can then be installed.

After crown molding 12, FIG. 1 is installed the two round locking knobs 52 can be loosened to release the pivoting flat upper body 48 and extension attachment 54 away from the crown molding 12. The supporting member 42 can then be slid down the vertical dovetail track 32 by loosening the thumb screw 46 located near the bottom of the supportive member 42, FIGS. 1, 2, and 3.

The base member 18 can then be disengaged from the nail 40 by pivoting the apparatus 10 to the left approximately 40 degrees on the wall's surface 14 and then sliding the apparatus to the right horizontally and then downward from behind the molding 12. Further nailing is recommended to securely fasten the crown molding 12 to the wall 14 and ceiling 16.

In the trade that the apparatus 10 would be used, a pair of these hangers would be suitable to support and position ceiling crown molding 12 on a wall surface 14 horizontally. Location of the apparatus 10 on a wall surface 14 can be determined by the length and stiffness of the ceiling molding being installed and the installer's preference as to its placement on the wall surface. A third apparatus hanger may be needed when installing 16′ lengths of MDR composite ceiling and crown moldings.

Apparatus 10 is comprised mainly of ABS plastic for durability and cost effectiveness and thumb screws of metal but could be of ABS plastic.

The lower portion 20 of the flat base 18 of the apparatus 10 that incorporates the sliding adjustment rod 22 and attached boot 24 with tightening thumb screw 46 can be temporarily detached from the flat base 18 of the apparatus 10 to allow the supportive member 42 to be vertically adjusted downward on the dovetail track 32 incorporated on the flat base 18 and locked into a fixed vertical position with an optional tightening thumb screw threaded hole 70 that can utilize the tightening thumb screw 46 to engage the dovetail track 32 on the flat base 18 to support and position much larger wall and ceiling crown moldings from the ceiling 16 vertically down the walls surface 14 for installation.

The invention claimed is:

1. An apparatus for supporting and positioning various dimensions, lengths and configurations of wall and ceiling crown molding horizontally on a wall and ceiling surface during installation encompassing;
a flat base in which the top portion has a 45 degree slot that extends upwardly toward a centered hole that can be hung on a partially driven common nail ⅞ inch down vertically from the ceiling;
a vertically attached centered dovetail track on the middle portion of a flat base with a supportive sliding body member that incorporates a vertically centered dovetail grove that slides on the dovetail track vertically centered on the middle portion of the flat base that can be locked in various vertical positions by means of a tightening thumb screw on its lower body;
a top portion of the supportive sliding body member incorporates a pivoting flat upper body that conforms to the angled face of crown molding and two round locking knobs as a means to secure the pivoting flat upper body to the proper angled position of crown molding during the installation;
a pivoting flat upper body that incorporates a dovetail track that accepts three sizes of extension attachments each having a dovetail grove and a tightening thumb screw as a means to secure the extension attachment to the dovetail track on the pivoting flat upper body; and
an extension rod and connecting boot incorporated on the bottom portion of the flat base can be adjusted and locked into position by means of a tightening thumb screw to allow the apparatus to hang vertically parallel to the wall surface when installing multiple buildup of wall and ceiling crown moldings horizontally.
